(19) United States
(12) Patent Application Publication
(10) Pub. No.: US 2006/0150226 A1
(43) Pub. Date: Jul. 6, 2006

(54) Television receiver for digital signals with offset tuning provisions

(76) Inventors: Raoul Monnier, Noyal Sur Vilaine (FR); Frederique Salou, Geveze (FR)

Correspondence Address: THOMSON LICENSING INC., PATENT OPERATIONS, PO BOX 5312, PRINCETON, NJ, 08543-5312, US

(21) Appl. No.: 10/562,999

(22) PCT Filed: Jun. 24, 2004
(86) PCT No.: PCT/EP04/51228

§ 371 Date: Dec. 28, 2005

(30) Foreign Application Priority Data
Jul. 1, 2003 (FR) 03/07933

(51) Int. Cl. H04N 5/455; H04N 7/173

(52) U.S. Cl. 725/100; 725/131; 348/726

(57) ABSTRACT

The method of demodulation in an STB comprising a tuner including a local oscillator, a demodulator situated downstream of the tuner and a digital telephone base. In case of interference with the digital telephone base, the frequency of the local oscillator of the tuner is shifted by one or more synthesis intervals after scanning of an error indicator situated in the demodulator. This method makes it possible to insert a digital telephone base into an STB while circumventing disturbances in the operation of the STB when this base is transmitting.

The invention relates to a method of demodulation in a digital STB comprising a tuner furnished with a local oscillator, a demodulator situated downstream of the tuner and a digital telephone base.

An STB (Set Top Box) is used in digital television as receiver/decoder. It comprises a tuner allowing frequency tuning of the signal received via satellite or cable. The tuner consists of input stages, of a mixer and is furnished with a local oscillator having a frequency determined as a function of the channel that one wishes to receive and making it possible to convert the high frequency received from the satellite into an intermediate frequency utilizable by a demodulator or directly into baseband (the signals still being phase-modulated and amplitude-modulated). The demodulator, situated downstream of the tuner, transforms the modulated signal into digital information utilizable by the remainder of the STB. It thus makes it possible to obtain audio, video and data signals. Said signals are processed so as to be restored by the circuits of the television set. The STB which is the subject of the invention furthermore comprises a digital telephone base.

The coexistence in an STB of the assembly consisting of the tuner and of the demodulator on the one hand (called the Front End), receiving signals at a very low level, and of the digital telephone base on the other hand, transmitting signals at very markedly higher levels, is very tricky.

Specifically, the strong signals transmitted by the digital telephone base may saturate the input stages of the Front End, thereby causing errors during the demodulation of the digital television signal by the demodulator of the STB. This problem appears even when the frequency bands used by the STB and the telephone are disjoint. Such is the case for example for a satellite STB, for which the frequencies used lie between 950 MHz and 2150 MHz, and a telephone operating in the ISM frequency band, that is to say between 2400 MHz and 2483.5 MHz.

The conventional screening techniques and the care taken in the design of the printed circuit are not sufficient to eliminate this interference completely.

One of the trickiest configurations to process is that corresponding to the case where the saturation of the input stages generates inside the tuner a frequency equal to the frequency of the local oscillator of the tuner. This unwanted frequency will disturb the operation of the local oscillator of the tuner (a phenomenon known as “local oscillator pulling”). The disturbance then affects the demodulator situated downstream of the tuner in a very marked manner, giving rise at the level of the image to the appearance of macroblocks, or even of freeze frames.

The invention proposes a solution for remedying the drawbacks cited above. Thus, the invention is a method of demodulation in a receiver/decoder comprising a tuner including a local oscillator, a demodulator situated downstream of the tuner and a digital telephone base. In case of interference with the digital telephone base, the frequency of the local oscillator of the tuner is shifted by one or more synthesis intervals after scanning of an error indicator situated in the demodulator.

Consequently, the method according to the invention makes it possible to insert a digital telephone base into an STB while circumventing the interference problems disturbing the operation of the STB when this digital telephone base is transmitting. Moreover, this method entails no extra cost, since it is implemented in a software manner on the basis of a very simple algorithm.

According to various details of the implementation of the invention, the process for scanning the error indicator is implemented in the sensitive part of the reception band of the receiver/decoder. The process for scanning the error indicator is implemented with each skip to a new channel. The process for scanning the error indicator runs as a background task.

The invention is also a receiver/decoder comprising a tuner including a local oscillator, a demodulator situated downstream of the tuner, a digital telephone base and a software program for scanning an error indicator situated in the demodulator, which acts so as to shift the frequency of the local oscillator of the tuner.

According to various details of implementation, the frequency shift of the local oscillator is effected by one or more synthesis intervals. The frequency shift of the local oscillator is at most equal to a shift automatically compensatable for by the demodulator.

The invention, its characteristics and its advantages are specified in the description which follows in conjunction with the figures mentioned below, which illustrate an embodiment thereof by way of example.

FIG. 1 shows an exemplary makeup of an STB with a digital telephone base.

FIG. 2 presents an example of frequency spectra emitted by a digital telephone base and received by an STB.

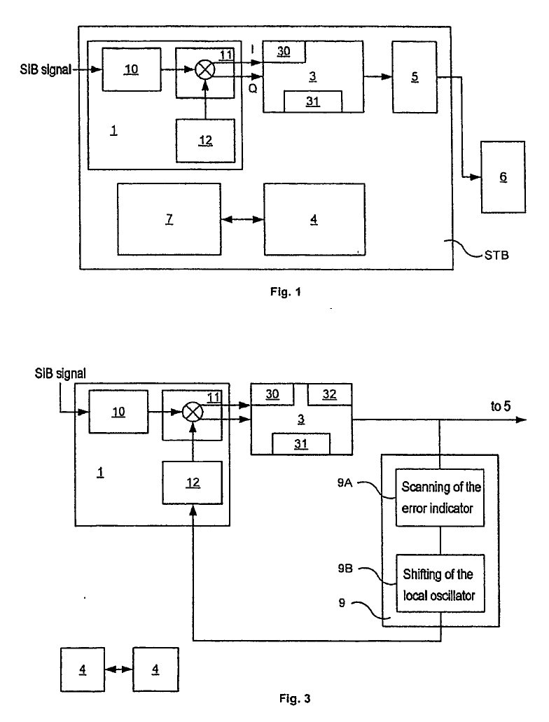

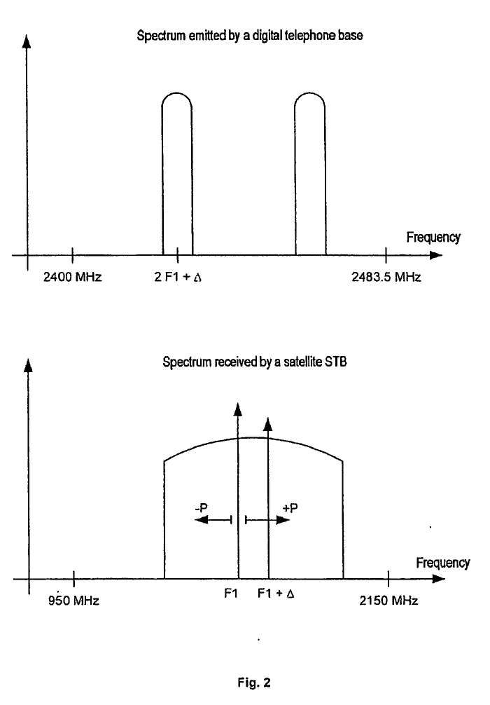

FIG. 3 shows a detail of an STB according to the invention.

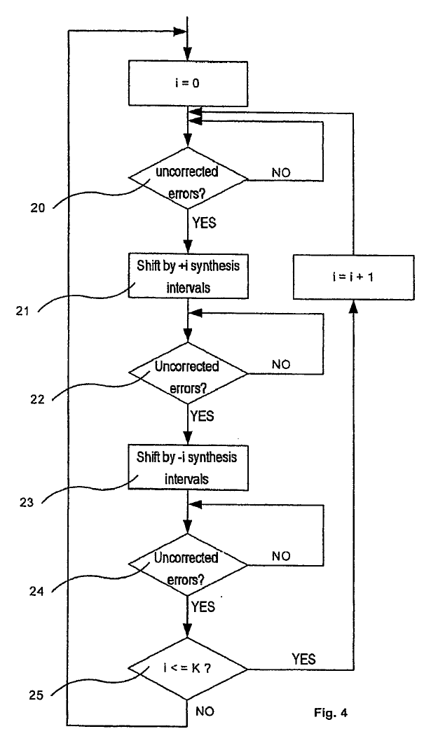

FIG. 4 presents a flowchart giving a possible implementation of the algorithm realizing the method of the invention.

FIG. 1 presents an embodiment of a satellite STB, whose SIB (Satellite Intermediate Band) input lies between 950 MHz and 2150 MHz, including a digital telephone base 4 operating in the ISM band, that is to say between 2400 MHz and 2483.5 MHz, with frequency hopping type modulation. The signals received via satellite are dispatched to input stages 10 of a tuner 1, so as to be filtered and amplified. The filtered and amplified signals then pass through a mixer 11, the second input of the mixer 11 being linked to a local oscillator 12 of the tuner 1. Passage through the mixer with a local oscillator 12 of the tuner 1 thus makes it possible to convert the high frequency received from the satellite into a baseband signal utilizable by a demodulator 3. In the embodiment described in the present example, the tuner 1 providing a baseband signal, the value of the local oscillator 12 of the tuner 1 therefore corresponds to the center frequency of the demodulated satellite channel. After passing through the tuner 1, the signal obtained is demodulated in a demodulator 3 situated downstream of the tuner 1, which is slaved to a carrier, in such a way as to provide digital information on output from the demodulator 3. The demodulator 3 also comprises an error correction device called an FEC (standing for Forward Error Correction) 30 intended to detect and correct errors. Furthermore, a carrier recovery loop 31 internal to the demodulator 3 makes it possible to compensate for any shifts in the tuner 1. It is thus possible to obtain the audio/video signals by virtue of an audio/video decoder 5, so as to restore them via the circuits of a television set 6. This STB also comprises a digital telephone base 4 linked to transmit/receive antennas 7.

FIG. 2 shows the frequency spectra emitted by the digital telephone base 4 and received by the STB. At a given instant, the digital telephone base 4 transmits a frequency spectrum of a width of 800 KHz situated on a grid lying between 2400 MHz and 2483.5 MHz, which corresponds to the ISM band. The center frequency of this spectrum, of value 2F1+Δ, where F1 represents the value of the local oscillator 12 of the tuner 1, changes regularly, thus performing a frequency hop. In the input stages 10 of the tuner 1, by beating with the satellite SIB signal received or a residual of the local oscillator 12 of the tuner 1 of frequency F1, the signal of the digital telephone base 4 produces a jammer 8 whose value F1+Δ may be very close to the value F1 of the local oscillator 12 of the tuner 1, as illustrated by FIG. 2. In this case, the operation of the local oscillator 12 of the tuner 1 is disturbed. This phenomenon is known by the name LO pulling. The part of the SIB band lying between 1200 MHz and 1241.75 MHz may be subject to this phenomenon. On the other hand, if the jammer 8 is sufficiently far from the local oscillator of the tuner 2, the disturbing phenomenon disappears.

The method according to the invention then consists, as represented in FIG. 2, in shifting the value of the local oscillator 12 of the tuner 1 by one or more synthesis intervals P, so as to distance it sufficiently from the jammer 8 generated. The synthesis interval P corresponds to the smallest possible variation in frequency for the local oscillator 12. The shift can be effected in one sense or in the other, according to +P or −P.

FIG. 3 shows the principle of operation of the method according to the invention in greater detail, more particularly at the level of the tuner 1 and of the demodulator 3. The shift of the local oscillator 12 of the tuner 1 is obtained through software 9, creating a loop between the output of the demodulator 3 and the local oscillator 12 of the tuner 1, in two steps: firstly by the scanning at 9A of an error indicator 32 situated in the digital demodulator 3; then by the deciding, if need be, of the shift at 9B of the local oscillator 12 of the tuner 1 by one or more synthesis intervals P. This process of artificial shifting of the local oscillator 12 of the tuner 1 is implemented in the part of the SIB spectrum liable to be perturbed by the disturbance due to the jammer 8, and if there is detection of errors not corrected by the FEC device of the demodulator 3.

This shifted tuning of the local oscillator 12 of the tuner 1 gives rise to a frequency offset. This offset is corrected at the level of the demodulator 3, allowing the carrier recovery loop 31 internal to the demodulator 3 to function naturally. Specifically, this carrier recovery loop 31 is capable of recouping frequency shifts of amplitude greater than the shift generated to distance the jammer 8 from the local oscillator 12.

The process for monitoring uncorrected errors is implemented in the sensitive part of the SIB band on each uncorrect skip to a new channel and runs as a background task so as to take account of the thermal drifting of the various local oscillators of the system, for example of the tuner 1 or of the digital telephone base 4.

FIG. 4 presents a flowchart giving a possible implementation of the algorithm realizing the method. The implementation commences for a zero shift i (the tuner is then tuned to the theoretical reception frequency) and scans the errors. For a shift i the uncorrected errors are scanned (block 20). If there is no uncorrected error, that is to say in the absence of disturbances of the jammer 8 on the local oscillator 12 of the tuner 1, the system remains on standby until an uncorrected error is detected. As soon as an uncorrected error is detected, the local oscillator 12 of the tuner 1 is shifted by +i synthesis intervals with respect to the theoretical reception frequency (block 21) so as to be distanced from the jammer 8. If no uncorrected errors remain after this shift, this signifies that the shifting of the local oscillator 12 of the tuner 1 has been sufficient, and the system remains on standby. In the converse case (block 22), the local oscillator 12 of the tuner 1 is shifted by −i synthesis intervals (block 23). If no uncorrected errors remain after this shift, this signifies that the shifting of the local oscillator 12 of the tuner 1 has been sufficient to circumvent the disturbances, and the system remains on standby. On the other hand, if uncorrected errors do remain (block 24) and if the synthesis interval remains less than or equal to K (block 25), the maximum number of possible shifts, the scan resumes with a shift i incremented by 1. If uncorrected errors remain and if the synthesis interval is greater than K, the scan recommences from a zero synthesis interval i.

Thus the method of demodulation according to the invention makes it possible to insert a digital telephone base 4 into an STB while circumventing the disturbances in the operation of the STB when this digital telephone base 4 is transmitting. This method, being implemented in software fashion based on a very simple algorithm, does not give rise to any extra cost either.

Numerous variants of the invention are possible. An STB furnished with a telephone base operating in the ISM band is described. However, such a telephone base may be replaced with another telephone base, for example a telephone of DECT or GSM type depending on the reason for the integration of the telephone base. Specifically, the telephone base may be added either in order to effect telephony via the reception medium of the STB (case of cable return paths), or in order to use a connection of the STB to a conventional telephone network which is used for certain interactive STBs, or to serve as return path to the STB. The same problems may arise depending on the frequencies used.

Additionally, a tuner which transposes the signals into baseband is described. The same problems arise in the case where the tuner transposes the signals into a low-frequency intermediate band. The problem occurs in the SIB band or cable in a frequency-shifted manner.

1. A method of demodulation in a receiver/decoder comprising a tuner including a local oscillator, a demodulator situated downstream of the tuner and a digital telephone base wherein, in case of interference with the digital telephone base, the frequency of the local oscillator of the tuner is shifted by one or more synthesis intervals after scanning of an error signal given by the error indicator situated in the demodulator.

2. A receiver/decoder comprising a tuner including a local oscillator, a demodulator situated downstream of the tuner and a digital telephone base, wherein it furthermore comprises a software program means for scanning an error signal issued from the error indicator situated in the demodulator, which acts so as to control the shifting of the frequency of the local oscillator of the tuner when the telephone base interferes with the local oscillator.

3. The receiver/decoder as claimed in claim 2, wherein the frequency shift of the local oscillator is effected in shifting the value of it by one or more synthesis intervals.

4. The receiver/decoder as claimed in claim 3, wherein the frequency shift of the local oscillator is at most equal to a shift automatically compensatable for by the demodulator.
